(19) United States
(12) Patent Application Publication
(10) Pub. No.: US 2025/0045517 A1
(43) Pub. Date: Feb. 6, 2025

(54) COPYWRITING GENERATION METHOD, ELECTRONIC DEVICE, AND STORAGE MEDIUM

(71) Applicant: Beijing Baidu Netcom Science Technology Co., Ltd., Beijing (CN)

(72) Inventor: En SHI, Beijing (CN)

(21) Appl. No.: 18/749,004

(22) Filed: Jun. 20, 2024

(30) Foreign Application Priority Data
Sep. 27, 2023 (CN) 202311266206.4

(51) Int. Cl. G06F 40/186

(52) U.S. Cl. CPC G06F 40/186

(57) ABSTRACT

A copywriting generation method, an electronic device and a storage medium are provided and relate to a field of artificial intelligence technology, in particular to fields of deep learning and natural language processing technologies, and may be applied to scenarios of large language models and generative dialogues. The copywriting generation method includes: updating, in response to an input copywriting requirement information being received, a copywriting prompt information in the copywriting requirement information according to a copywriting generation operation related to the copywriting requirement information, so as to obtain a first target copywriting requirement information, where the first target copywriting requirement information includes a target copywriting prompt information related to a semantic attribute of the copywriting requirement information; and processing the first target copywriting requirement information based on a pre-trained deep learning model, so as to generate a first feedback copywriting corresponding to the copywriting requirement information.

This application claims priority to Chinese Patent Application No. 202311266206.4, filed on Sep. 27, 2023, the entire content of which is incorporated herein in its entirety by reference.

### TECHNICAL FIELD

The present disclosure relates to a field of artificial intelligence technology, in particular to fields of deep learning and natural language processing technologies, and may be applied to scenarios of large language models and generative dialogues, and more specifically, relates to a copywriting generation method, an electronic device, and a storage medium.

### BACKGROUND

With a rapid development of artificial intelligence technology, users may use large models to complete complex data processing tasks such as image processing and text generation. A large model may refer to a deep learning model that has a large number of model parameters up to billions. By means of a large number of model parameters, a deep learning model may complete complex data processing tasks.

### SUMMARY

The present disclosure provides a copywriting generation method, an electronic device, and a storage medium.

According to an aspect of the present disclosure, a copywriting generation method is provided, including: updating, in response to an input copywriting requirement information being received, a copywriting prompt information in the copywriting requirement information according to a copywriting generation operation related to the copywriting requirement information, so as to obtain a first target copywriting requirement information, where the first target copywriting requirement information includes a target copywriting prompt information related to a semantic attribute of the copywriting requirement information; and processing the first target copywriting requirement information based on a pre-trained deep learning model, so as to generate a first feedback copywriting corresponding to the copywriting requirement information.

According to another aspect of the present disclosure, an electronic device is provided, including: at least one processor; and a memory communicatively connected to the at least one processor, where the memory stores instructions executable by the at least one processor, and the instructions, when executed by the at least one processor, are configured to cause the at least one processor to implement the method provided by embodiments of the present disclosure.

According to another aspect of the present disclosure, a non-transitory computer-readable storage medium having computer instructions therein, where the computer instructions are configured to cause a computer to implement the method provided by embodiments of the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure. In the accompanying drawings:

FIG. 1 schematically shows an exemplary system architecture to which a copywriting generation method and a copywriting generation apparatus may be applied according to embodiments of the present disclosure;

FIG. 2 schematically shows a flowchart of a copywriting generation method according to embodiments of the present disclosure;

FIG. 3 schematically shows an example diagram of a copywriting prompt template according to embodiments of the present disclosure;

FIG. 4 schematically shows an application scenario diagram of a copywriting generation method according to embodiments of the present disclosure;

FIG. 5 schematically shows an application scenario diagram of a copywriting generation method according to other embodiments of the present disclosure;

FIG. 6 schematically shows an architecture diagram of a large model service platform according to embodiments of the present disclosure;

FIG. 7 schematically shows a block diagram of an copywriting generation apparatus according to embodiments of the present disclosure; and

FIG. 8 shows a schematic block diagram of an example electronic device 800 suitable for implementing a copywriting generation method according to embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as just exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

In technical solutions of the present disclosure, an acquisition, a storage and an application, etc. of user personal information involved comply with provisions of relevant laws and regulations, take necessary security measures, and do not violate public order and good custom.

With a development of artificial intelligence technology, more and more enterprises use large models to improve office efficiency and service development speed. For example, relevant large model service providers may open model application service interfaces to enterprises, so that relevant enterprises may conveniently complete office works such as text editing, image generation, personalized copywriting production, and script development through the service interfaces.

Embodiments of the present disclosure provide a copywriting generation method, a copywriting generation apparatus, an electronic device, a storage medium, and a program product. The copywriting generation method includes: updating, in response to an input copywriting requirement information being received, a copywriting prompt information in the copywriting requirement information according to a copywriting generation operation related to the copywriting requirement information to obtain a first target copywriting requirement information, where the first target copywriting requirement information includes a target copywriting prompt information related to a semantic attribute of the copywriting requirement information; and processing the first target copywriting requirement information based on a pre-trained deep learning model to generate a first feedback copywriting corresponding to the copywriting requirement information.

According to embodiments of the present disclosure, by updating the copywriting requirement information input by the user according to the copywriting generation operation, it is possible to obtain a first target copywriting requirement information that includes a target copywriting prompt information indicating the semantic attribute of the copywriting requirement information. Therefore, when the first target copywriting requirement information is input into the deep learning model, the deep learning model accurately understands the semantic attribute of the copywriting requirement information, so that the obtained first feedback copywriting accurately meets a copywriting requirement of the user, a copywriting generation accuracy is improved, and an office efficiency is improved.

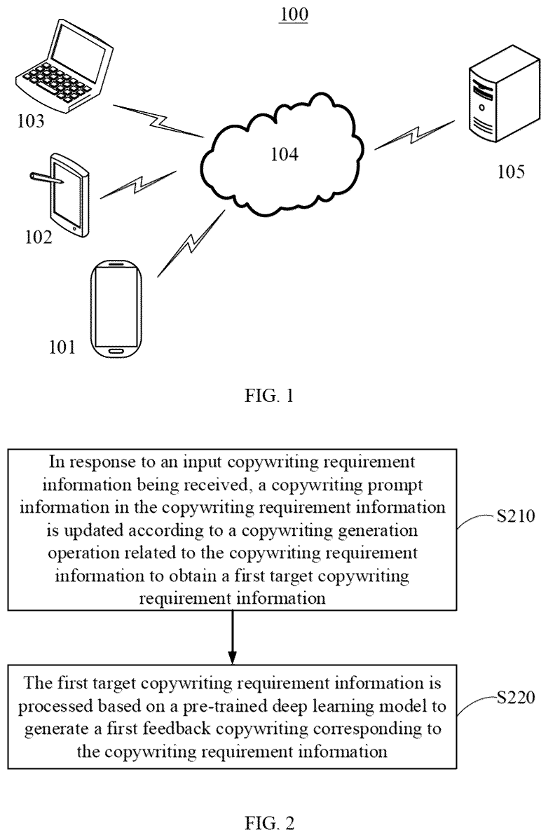

FIG. 1 schematically shows an exemplary system architecture to which a copywriting generation method and a copywriting generation apparatus may be applied according to embodiments of the present disclosure.

It should be noted that FIG. 1 only shows an example of the system architecture to which embodiments of the present disclosure may be applied, so as to help those skilled in the art understand technical contents of the present disclosure. However, it does not mean that embodiments of the present disclosure may not be applied to other devices, systems, environments or scenarios. For example, in other embodiments, the exemplary system architecture to which a copywriting generation method and a copywriting generation apparatus may be applied may include a terminal device, and the terminal device may implement the copywriting generation method and the copywriting generation apparatus without interacting with a server.

As shown in FIG. 1, a system architecture 100 according to such embodiments may include terminal devices 101, 102 and 103, a network 104, and a server 105. The network 104 is a medium for providing a communication link between the terminal devices 101, 102, 103 and the server 105. The network 104 may include various connection types, such as wired and/or wireless communication links, etc.

The terminal devices 101, 102 and 103 may be used by a user to interact with the server 105 through the network 104 to receive or send messages, etc. The terminal devices 101, 102 and 103 may be installed with various communication client applications, such as knowledge reading applications, web browser applications, search applications, instant messaging tools, email clients and/or social platform software, etc. (just for example).

The terminal devices 101, 102 and 103 may be various electronic devices having display screens and supporting web browsing, including but not limited to smart phones, tablet computers, laptop computers, and desktop computers, etc.

The server 105 may be a server providing various services, such as a background management server (just for example) that provides a support for content browsed by the user using the terminal devices 101, 102 and 103. The background management server may analyze and process received data such as a user request, and feed back a processing result (such as a web page, an information, or data acquired or generated according to the user request) to the terminal devices.

The server 105 may also be a cloud server, also known as a cloud computing server or a cloud host, which is a host product in a cloud computing service system to solve shortcomings of difficult management and weak service scalability existing in a conventional physical host and VPS (Virtual Private Server) service. The server 105 may also be a server of a distributed system or a server combined with a block-chain.

It should be noted that the copywriting generation method provided by embodiments of the present disclosure may generally be performed by the server 105. Correspondingly, the copywriting generation apparatus provided by embodiments of the present disclosure may be generally arranged in the server 105. The copywriting generation method provided by embodiments of the present disclosure may also be performed by a server or server cluster different from the server 105 and capable of communicating with the terminal devices 101, 102, 103 and/or the server 105. Correspondingly, the copywriting generation apparatus provided by embodiments of the present disclosure may also be arranged in a server or server cluster different from the server 105 and capable of communicating with the terminal devices 101, 102, 103 and/or the server 105.

It should be understood that the number of terminal devices, networks and servers shown in FIG. 1 are just schematic. According to implementation needs, any number of terminal devices, networks and servers may be provided.

FIG. 2 schematically shows a flowchart of a copywriting generation method according to embodiments of the present disclosure.

As shown in FIG. 2, the copywriting generation method includes operation S210 to operation S220.

In operation S210, in response to an input copywriting requirement information being received, a copywriting prompt information in the copywriting requirement information is updated according to a copywriting generation operation related to the copywriting requirement information to obtain a first target copywriting requirement information. The first target copywriting requirement information includes a target copywriting prompt information related to a semantic attribute of the copywriting requirement information.

In operation S220, the first target copywriting requirement information is processed based on a pre-trained deep learning model to generate a first feedback copywriting corresponding to the copywriting requirement information.

According to embodiments of the present disclosure, the copywriting generation operation may include an operation indicative of generating a copywriting according to the copywriting requirement information. A specific operation type of the copywriting generation operation is not limited in embodiments of the present disclosure and may be selected by those skilled in the art according to actual requirements.

According to embodiments of the present disclosure, the copywriting requirement information may represent a relevant requirement for a copywriting that needs to be generated for a target object, such as a format requirement, a content requirement, etc. for the copywriting that needs to be generated. The copywriting prompt information may be a semantic attribute-related information input by the target object. For example, the copywriting prompt information may be “please find words that are not spelled correctly in the text”. For another example, the copywriting prompt information may be the whole of the copywriting requirement information. A specific type of the copywriting prompt information is not limited in embodiments of the present disclosure.

According to embodiments of the present disclosure, the target copywriting prompt information may be obtained by updating the copywriting prompt information in the copywriting requirement information. For example, the copywriting prompt information in the copywriting requirement information may be updated based on a deep learning algorithm. However, the present disclosure is not limited to this, and the copywriting prompt information in the copywriting requirement information may also be updated based on other methods. For example, the copywriting prompt information may be updated based on a configuration template, so as to obtain the target copywriting prompt information. The specific method of updating the copywriting prompt information in the copywriting requirement information is not limited in embodiments of the present disclosure and may be selected by those skilled in the art according to actual requirements.

According to embodiments of the present disclosure, the target copywriting prompt information may accurately represent the semantic attribute of the copywriting requirement information. Therefore, by processing the first target copywriting requirement information according to the pre-trained deep learning model, the first feedback copywriting is generated on the basis of fully understanding the semantic attribute of the copywriting requirement information by the deep learning model, so that a matching degree between the first feedback copywriting and the copywriting requirement of the target object may be improved, which may avoid generating a low-quality feedback copywriting due to an erroneous understanding of semantics of the copywriting requirement information by the deep learning model, improve an overall quality level of the automatically generated copywriting, and then improve the office efficiency of the target object.

According to embodiments of the present disclosure, the pre-trained deep learning model may be constructed based on any type of deep learning algorithm. The specific model parameters of the deep learning model are not limited in embodiments of the present disclosure and may be selected by those skilled in the art according to actual requirements.

According to embodiments of the present disclosure, a copywriting type of the first feedback copywriting may be a speech copywriting type, an information collection type, a reply information type, or a text rewriting type; or a copywriting type of the first feedback copywriting may be a combination of two or more of a speech copywriting type, an information collection type, a reply information type, and a text rewriting type.

According to embodiments of the present disclosure, the speech copywriting type of the first feedback copywriting may include a speech script, a product explanation script, and other copywriting that needs to be expressed by the target object through spoken language. According to the copywriting generation method provided by embodiments of the present disclosure, it is possible to improve a colloquial attribute of the speech type of the first feedback copywriting, and it is also possible to improve, according to a specific speech scenario of the first feedback copywriting represented by the target copywriting prompt information, a matching degree between the colloquial attribute of the first feedback copywriting and the speech scenario to improve a quality of the first feedback copywriting.

According to embodiments of the present disclosure, the information collection type of the first feedback copywriting may include copywriting obtained by collection of any type of information, such as service information collection, image information collection, etc. According to the copywriting generation method provided by embodiments of the present disclosure, it is possible to improve a matching degree between the information collected in the first feedback copywriting and the requirement of the target object according to the semantic attribute represented by the target copywriting prompt information, so as to avoid an omission of important information, reduce an amount of redundant information collected, and thus improve the quality of the first feedback copywriting.

According to embodiments of the present disclosure, the reply information type of the first feedback copywriting may include a question information or an answer information in a question and answer scenario. The reply information type of the first feedback copywriting may be, for example, an intelligent response information for the target object in an e-commerce sales scenario.

According to embodiments of the present disclosure, the text rewriting type of the first feedback copywriting may include a copywriting obtained by rewriting any type of text, such as a news text, a notification text, a novel, etc. According to the copywriting generation method provided by embodiments of the present disclosure, it is possible to rewrite the copywriting requirement information in a manner matched with the semantic attribute, based on the semantic attribute represented by the target copywriting prompt information, such as a style attribute or a format attribute for text rewriting, so as to improve a matching degree between the first feedback copywriting and a rewriting requirement of the target object, and improve the quality of the first feedback copywriting.

It should be noted that the copywriting type of the first feedback copywriting may also be a code script editing type, a comment content type or other type, or a combination thereof. The specific copywriting type of the first feedback copywriting is not limited in embodiments of the present disclosure and may be selected by those skilled in the art according to actual requirements.

According to embodiments of the present disclosure, the copywriting requirement information is associated with an association requirement information, and an association prompt information corresponding to the association requirement information is matched with the copywriting prompt information.

It should be noted that the association requirement information may be an information that has established an association relationship with the copywriting requirement information, which may include, for example, a copywriting requirement information input by the target object in a historical time period, or a copywriting requirement information input by other objects. The specific method of obtaining the association requirement information is not limited in embodiments of the present disclosure and may be selected by those skilled in the art according to actual requirements.

According to embodiments of the present disclosure, updating the copywriting prompt information in the copywriting requirement information according to the copywriting generation operation related to the copywriting requirement information to obtain the first target copywriting requirement information may include: in response to a operation type of the copywriting generation operation being a first operation type, updating the copywriting prompt information according to the association requirement information and the copywriting requirement information to obtain the first target copywriting requirement information.

According to embodiments of the present disclosure, the first operation type may indicate that, in this type, the association requirement information and the copywriting requirement information as a whole serve as the copywriting requirement of the target object. By updating the copywriting prompt information according to the processed association requirement information and the copywriting requirement information, it is possible to further accurately understand the semantic attribute of the copywriting generation requirement of the target object through the association requirement information and the copywriting requirement information, so that a representation accuracy of the obtained first target copywriting requirement information for the semantic attribute may be improved, and then the copywriting quality of the first feedback copywriting may be further improved.

In some embodiments of the present disclosure, it is possible to process the association requirement information and the copywriting requirement information based on a prompt information optimizer constructed based on a neural network algorithm, so as to obtain the first target copywriting requirement information. A quantity of model parameters of the prompt information optimizer may be less than that of the deep learning model.

According to embodiments of the present disclosure, updating the copywriting prompt information according to the association requirement information and the copywriting requirement information may include: performing a feature extraction on the association requirement information and the copywriting requirement information to obtain an association requirement feature and a copywriting requirement feature, respectively; fusing the association requirement feature and the copywriting requirement feature based on an attention mechanism to obtain a fusion requirement feature; and updating the copywriting prompt information according to the fusion requirement feature.

According to embodiments of the present disclosure, the feature extraction may be performed on the association requirement information and the copywriting requirement information based on an encoder, so as to obtain the association requirement feature and the copywriting requirement feature, respectively. The association requirement feature and the copywriting requirement feature may be fused based on an attention network algorithm, such as Transformer algorithm, so that a semantic feature of the association requirement information and a semantic feature of the copywriting requirement information may be fully fused in the obtained fusion requirement feature, and a representation capability of the fusion requirement feature for the semantic attribute of the target object may be improved.

According to embodiments of the present disclosure, updating the copywriting prompt information according to the fusion requirement feature may include inputting the fusion requirement feature into a fully connected network layer and outputting the target copywriting prompt information.

According to embodiments of the present disclosure, the association requirement information includes a historical requirement information associated with the target object, and the copywriting requirement information is generated based on a requirement information input operation corresponding to the target object.

In some embodiments of the present disclosure, the association requirement information may include a preceding requirement information of the copywriting requirement information, such as a preceding text related to a current copywriting requirement information input by the target object in a historical time period.

According to embodiments of the present disclosure, the copywriting generation method may further include: determining, from a predetermined copywriting prompt template library, a recommended copywriting prompt template matched with the semantic attribute of the copywriting requirement information according to the copywriting requirement information.

According to embodiments of the present disclosure, it is possible to process the copywriting requirement information by a neural network algorithm to obtain a classification result for the copywriting requirement information, and determine a recommended copywriting prompt template from the predetermined copywriting prompt template library according to the classification result.

According to embodiments of the present disclosure, the predetermined copywriting prompt template library may include a predetermined copywriting prompt template, and the copywriting prompt template may be determined according to a deep learning model. For example, it is possible to input a sample copywriting requirement information containing a copywriting prompt template into the deep learning model, and output a sample feedback copywriting. When an evaluation result of the sample feedback copywriting meets an evaluation condition, the copywriting prompt template may be stored in the copywriting prompt template library, so that the pre-trained deep learning model may accurately understand the semantic attribute of the copywriting prompt template in the copywriting prompt template library. In this way, by determining the recommended copywriting prompt template matched with the copywriting requirement information from the copywriting prompt template library, it is possible to further obtain a feedback copywriting matched with the copywriting requirement information for the target object through the recommended copywriting prompt template.

It should be understood that the recommended copywriting prompt template may include the target copywriting prompt information.

According to embodiments of the present disclosure, determining the recommended copywriting prompt template matched with the semantic attribute of the copywriting requirement information from the predetermined copywriting prompt template library according to the copywriting requirement information may include: performing a semantic feature extraction on the copywriting requirement information to obtain a copywriting requirement feature; matching a copywriting prompt template feature associated with a copywriting prompt template with the copywriting requirement feature to obtain a feature matching result, where the copywriting prompt template is contained in the predetermined copywriting prompt template library; and determining, from the predetermined copywriting prompt template library, the recommended copywriting prompt template matched with the semantic attribute of the copywriting requirement information according to the feature matching result.

According to embodiments of the present disclosure, matching the copywriting prompt template feature associated with the copywriting prompt template with the copywriting requirement feature may include: calculating a similarity between the copywriting prompt template feature and the copywriting requirement feature to obtain a feature similarity result, and determining the feature matching result according to a comparison result between the feature similarity result and a predetermined similarity threshold.

According to embodiments of the present disclosure, when the feature matching result indicates that the copywriting prompt template feature is matched with the copywriting requirement feature, the copywriting prompt template associated with the feature matching result may be determined as the recommended copywriting prompt template matched with the semantic attribute of the copywriting requirement information.

According to embodiments of the present disclosure, the copywriting generation method may further include: generating a second target copywriting requirement information in response to an editing operation on the recommended copywriting prompt template; and processing the second target copywriting requirement information according to a deep learning model to generate a second feedback copywriting.

According to embodiments of the present disclosure, a requirement keyword related to a requirement attribute may be added to the recommended copywriting prompt template by the target object performing an editing operation on the recommended copywriting prompt template. For example, it is possible to add “two” (requirement keyword) to a position of {number} in the recommended copywriting prompt template. For another example, it is possible to add “snow scene” (requirement keyword) to a position of {theme} in the recommended copywriting prompt template, so as to complete the editing operation and obtain the second target copywriting requirement information.

According to embodiments of the present disclosure, it is also possible to generate the second target copywriting requirement information by the target object editing the recommended copywriting prompt template, so as to achieve a personalized representation of the copywriting generation requirement for the target object.

According to embodiments of the present disclosure, the pre-trained deep learning model may accurately understand the semantic attribute in the second target copywriting requirement information. Therefore, when processing the second target copywriting requirement information using the deep learning model, it is possible to obtain a second feedback copywriting that may accurately represent the copywriting generation requirement of the target object, so that a quality level of the copywriting may be improved.

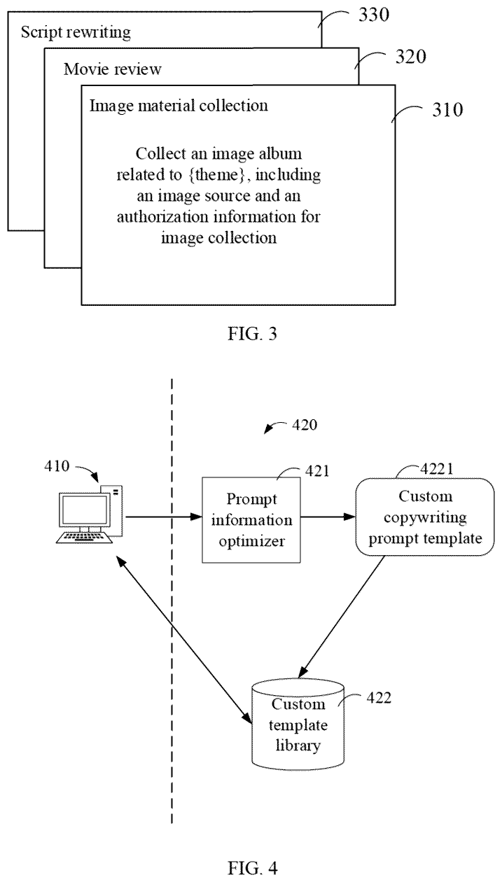

FIG. 3 schematically shows an example diagram of a copywriting prompt template according to embodiments of the present disclosure.

As shown in FIG. 3, a first copywriting prompt template 310 may be related to “image material collection”, and the first copywriting prompt template 310 may contain a template copywriting prompt information “collect an image album related to {theme}, including an image source and an authorization information for image collection”, where “{theme}” may be an embedding position corresponding to a requirement keyword of a theme attribute.

As shown in FIG. 3, a second copywriting prompt template 320 may be related to “movie review”, and a third copywriting prompt template 330 may be related to “script rewriting”. It is possible to construct a predetermined copywriting prompt template library based on the first copywriting prompt template 310, the second copywriting prompt template 320 and the third copywriting prompt template 330.

According to embodiments of the present disclosure, the copywriting generation method may further include: extracting a requirement keyword related to the requirement attribute from the copywriting requirement information.

According to embodiments of the present disclosure, the requirement keyword may be extracted based on a keyword extraction method. For example, it is possible to perform a part-of-speech tagging on text words in the copywriting requirement information, and extract the requirement keyword from the copywriting requirement information according to respective parts of speech of the text words and a grammatical relationship between the text words. However, the present disclosure is not limited to this, and the requirement keyword may also be extracted from the copywriting requirement information based on other types of keyword extraction methods. The specific method of extracting the requirement keyword is not limited in embodiments of the present disclosure.

According to embodiments of the present disclosure, updating the copywriting prompt information in the copywriting requirement information according to the copywriting generation operation related to the copywriting requirement information to obtain the first target copywriting requirement information may include: in response to a operation type of the copywriting generation operation being a second operation type, determining an embedding position corresponding to the requirement keyword from the recommended copywriting prompt template; and embedding the requirement keyword into the recommended copywriting prompt template based on the embedding position to obtain the first target copywriting requirement information.

According to embodiments of the present disclosure, the second operation type of the copywriting generation operation may indicate that, in this type, a first target copywriting requirement information is generated through the recommended copywriting prompt template, and then a first feedback copywriting is automatically generated according to the first target copywriting requirement information. It is possible to generate a first copywriting generation operation object indicating the first operation type and a second copywriting generation operation object indicating the second operation type in an interactive interface related to the target object, so that a specific method of obtaining the first feedback copywriting may be conveniently selected by the target object.

According to embodiments of the present disclosure, the embedding position in the recommended copywriting prompt template may be represented by a prompt symbol such as “{ }”, “.”, etc. The embedding position corresponding to the requirement keyword may be determined through a corresponding relationship between a part-of-speech attribute identification related to the embedding position and the part-of-speech of the requirement keyword, so that the requirement keyword may be automatically embedded into the recommended copywriting prompt template.

According to embodiments of the present disclosure, it is also possible to train a neural network model through the copywriting prompt template and process the copywriting requirement information according to the trained neural network model, so as to determine the embedding position corresponding to the requirement keyword from the recommended copywriting prompt template according to the neural network model; and embed the requirement keyword into the recommended copywriting prompt template based on the embedding position, so as to obtain the first target copywriting requirement information.

It should be noted that the neural network model may be constructed based on an attention network algorithm. For example, it is possible to construct the neural network model based on BERT (Bidirectional Encoder Representations from Transformers) algorithm, so as to improve a timeliness of obtaining the first target copywriting requirement information and reduce a delay in obtaining the feedback copywriting.

According to embodiments of the present disclosure, the copywriting generation method may further include: updating a custom template library corresponding to the target object according to the recommended copywriting prompt template to obtain an updated custom template library. A custom copywriting prompt template in the custom template library is presented to the target object when an operation authority of the target object is verified successfully.

According to embodiments of the present disclosure, by providing a corresponding operation authority for the target object, it is possible to allow the target object to access and operate the custom template library in a timely manner. The custom template library may include a copywriting prompt template that is adapted to the copywriting requirement attribute of the target object. It is possible to allow the target object to edit the custom copywriting prompt template in the custom template library, such as filling in the requirement keyword, so as to conveniently generate the second target copywriting requirement information for the target object, which may save a computational overhead of determining the recommended copywriting prompt template and facilitate the target object to quickly obtain the second feedback copywriting according to the actual copywriting generation requirement.

According to embodiments of the present disclosure, by updating the custom template library corresponding to the target object according to the recommended copywriting prompt template, it is possible to update the custom template library in a timely manner according to the copywriting generation requirement of the target object, so that the second target copywriting requirement information may be quickly obtained by the target object according to a latest custom copywriting prompt template in the custom template library in a subsequent copywriting generation operation, and then a copywriting quality of the second feedback copywriting may be improved.

According to embodiments of the present disclosure, the copywriting generation method may further include: in response to a template optimization operation corresponding to the target object, processing a copywriting prompt template to be optimized corresponding to the template optimization operation according to an attention mechanism algorithm to obtain an optimized custom copywriting prompt template; and updating the custom template library corresponding to the target object according to the optimized custom copywriting prompt template to obtain an updated custom template library.

FIG. 4 schematically shows an application scenario diagram of a copywriting generation method according to embodiments of the present disclosure.

As shown in FIG. 4, the application scenario may include a client 410 and a server 420. The server 420 may include a prompt information optimizer 421 constructed based on an attention network algorithm and a custom template library 422 associated with the target object.

A template optimization operation may be performed by the target object through the client 410, and the copywriting prompt template to be optimized may be sent to the prompt information optimizer 421. The prompt information optimizer 421 may process the copywriting prompt template to be optimized corresponding to the template optimization operation according to an attention mechanism algorithm to obtain an optimized custom copywriting prompt template 4221. The custom copywriting prompt template 4221 may be stored in the custom template library 422 to update the custom template library.

The custom template library 422 may be accessed by the target object through the client 410, and any custom prompt information template may be called from the custom template library 422.

According to embodiments of the present disclosure, the copywriting prompt template to be optimized is generated based on a prompt information editing operation corresponding to the target object.

According to the copywriting generation method provided by embodiments of the present disclosure, it is also possible to use a prompt information edited by the target object as the copywriting prompt template to be optimized, so that the prompt information edited by the target object may be input into the prompt information optimizer 421, and an optimized custom copywriting prompt template may be obtained to meet a personalized copywriting generation requirement of the target object.

According to embodiments of the present disclosure, the copywriting prompt template to be optimized may also be determined from a custom template library corresponding to the target object.

According to the copywriting generation method provided by embodiments of the present disclosure, it is also possible to optimize the custom copywriting prompt template generated in a historical time period, so as to ensure that the optimized custom copywriting prompt template may meet a current copywriting generation requirement of the target object.

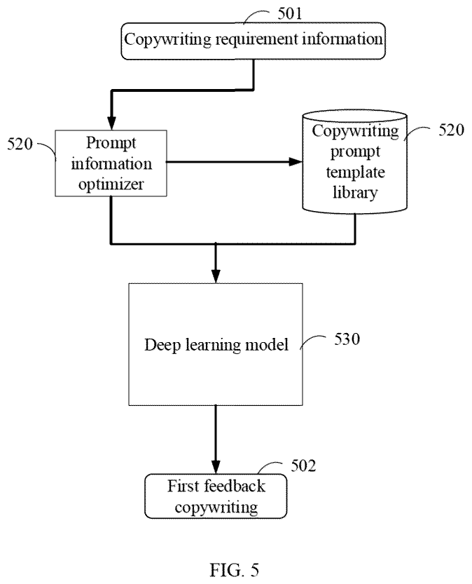

FIG. 5 schematically shows an application scenario diagram of a copywriting generation method according to other embodiments of the present disclosure.

As shown in FIG. 5, the application scenario may include a prompt information optimizer 510, a custom template library 520, and a deep learning model 530. The deep learning model 530 may be a natural language processing model.

When a copywriting requirement information 501 input by the target object includes a requirement keyword and the operation type of the copywriting generation operation is detected as the first operation type, the copywriting requirement information 501 may be input into the prompt information optimizer 510. The prompt information optimizer 510 may update a copywriting prompt information in the copywriting requirement information 501 to obtain a first target copywriting requirement information containing a target copywriting prompt information. The first target copywriting requirement information may be input into the deep learning model 530 to output a first feedback copywriting 502.

As shown in FIG. 5, the target copywriting prompt information may be used as an optimized custom copywriting prompt template related to the target object, and the custom copywriting prompt template may be input into the custom template library 520 related to the target object for calling by the target object at any time.

According to embodiments of the present disclosure, the copywriting generation method may further include: in response to a model update request related to the target object, determining a training sample according to the updated custom template library; and training a deep learning model according to the training sample to obtain an updated target deep learning model.

According to embodiments of the present disclosure, the training sample may be obtained by adding a sample keyword to the custom copywriting prompt template in the custom template library, or by masking an embedding position corresponding to the sample keyword in the custom copywriting prompt template. The specific method of obtaining the training sample is not limited in embodiments of the present disclosure and may be selected by those skilled in the art according to actual requirements.

According to embodiments of the present disclosure, the deep learning model may be trained by self-supervised training. For example, it is possible to train the deep learning model by providing a learning task for the deep learning model, or it is possible to perform a sample labeling on a training sample to obtain a training sample associated with a label and then train the deep learning model by supervised training to obtain an updated target deep learning model. The specific training method is not limited in embodiments of the present disclosure.

According to embodiments of the present disclosure, a model training interface may be encapsulated for a client related to the target object, so that a deep learning model may be timely trained by the target object according to a custom template library highly relevant to service requirement or text generation requirement, and then an updated deep learning model that may accurately generate a feedback copywriting may be obtained in real time. By providing an interface to the client of the target object, it is possible to allow the target object to conveniently fine-tune the model parameter of the deep learning model, so as to improve an adaptability of the updated target deep learning model to the service requirement or copywriting generation requirement of the target object, and improve a matching degree between a feedback file generated by the target deep learning model and the actual requirement of the target object.

According to embodiments of the present disclosure, training the deep learning model according to the training sample to obtain the updated target deep learning model may include: executing an i^{th} training task on an (i−1)^{th} candidate deep learning model according to the training sample to obtain an i^{th} candidate model parameter of an i^{th} candidate deep learning model; obtaining respective candidate model parameters of I candidate deep learning models in a case of I=i, where I≥i>1, and a first candidate deep learning model is the deep learning model; determining a target model parameter from I candidate model parameters according to a model selection operation related to the target object; and obtaining the updated target deep learning model according to the target model parameter.

According to embodiments of the present disclosure, it is possible to record the candidate model parameter of the candidate deep learning model and a sample candidate feedback copywriting output by the candidate deep learning model after each training task is completed, so that the sample candidate feedback copywriting may be viewed by the target object and a model selection operation may be performed by the target object for the candidate model parameter to select an optimal candidate model parameter as the target model parameter, and then the updated target deep learning model may be obtained according to the target model parameter.

According to embodiments of the present disclosure, by retraining the deep learning model having a large number of model parameters according to the model update request of the target object, it is possible to adjust the model parameter of the deep learning model according to the service requirement of the target object, so that the target deep learning model may meet the personalized requirement of the target object, and the quality level of the generated copywriting may be improved.

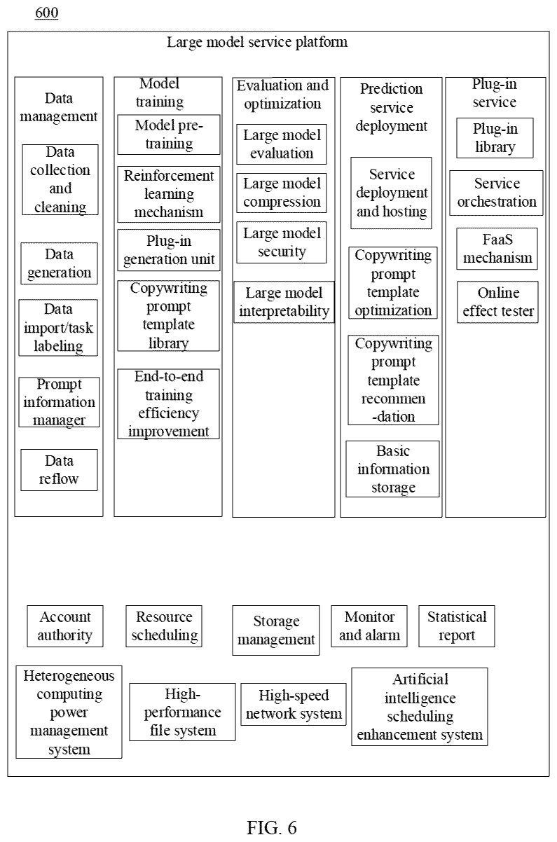

FIG. 6 schematically shows an architecture diagram of a large model service platform according to embodiments of the present disclosure.

As shown in FIG. 6, a large model service platform 600 may include a data management module, a model training module, an evaluation and optimization module, a prediction service deployment module and a plug-in service module, a total of five service modules. These five service modules constitute a large model tool chain to provide a comprehensive service support such as large model training, model application, and model evaluation for the target object.

The data management module may include service units having data management functions such as data collection and cleaning, data generation, data import/task labeling, prompt information manager, and data reflow. The data management module may support processing and management of massive large-scale data, and further provide an efficient data labeling capability to help the target object build high-quality data, so that a model training may be better driven by the high-quality data, and an application function of the model may be improved.

The model training module may include functional service units that assist model training, such as model pre-training, reinforcement learning mechanism, plug-in generation unit, copywriting prompt template library, and end-to-end training efficiency improvement. The model training module may provide common training service functions such as retraining, fine-tuning, and reinforcement learning. A deep learning model that meets the service requirement may be trained by the target object.

The prediction service deployment module may include service units, such as service deployment and hosting, copywriting prompt template optimization, copywriting prompt template recommendation, basic information storage. The prediction service deployment module may provide a feedback copywriting for the target object based on the copywriting generation method provided in embodiments of the present disclosure, and may further provide a custom template library update service to facilitate the target object to improve the quality of the feedback copywriting through a high-quality prompt information template. Moreover, the prediction service deployment module may provide service functions for arrangement, rewriting and presetting, etc. of the prompt information template.

The evaluation and optimization module may include service functional units, such as large model evaluation, large model compression, large model security, and large model interpretability, etc. The evaluation and optimization module may provide an efficient model evaluation and optimization function, thereby improving a training efficiency of the deep learning model.

The plug-in service module may include a plug-in library, a service orchestration, an FaaS (Function-as-a-Service) mechanism, an online effect tester and other functional service units. A capability boundary of the large model may be further expanded through the plug-in library, the service orchestration and other means, so that relevant enterprises may flexibly apply service rules and improve a service innovation efficiency during a process of service innovation.

In addition, the large model service platform 600 may further include a heterogeneous computing power management system, a high-performance file system, a high-speed network system, an artificial intelligence scheduling enhancement system and other artificial intelligence basic service systems.

The heterogeneous computing power management system may efficiently manage various types of computing power units, and manage computing power devices of different specifications such as GPU (Graphic Processing Unit), NPU (Neural network Processing Unit), XPU (eXtreme Processing Unit), etc., so that the computing power units and the computing power devices may be used for different tasks or may cooperate to complete different portions of a job.

The high-performance file system may significantly improve an efficiency of file reading and writing during a process of large model training and inference.

The high-speed network system may provide distributed training service functions or inference service functions during the training and inference process of the large model, and frequently update and synchronize model parameters between different nodes, which places extremely high requirements on a network bandwidth. A high-speed Internet network based on RDMA (Remote Direct Memory Access) protocol may greatly improve an efficiency of distributed training and pushing.

The artificial intelligence scheduling enhancement system may provide intelligence of task and job scheduling, rationally utilize existing service resources, improve service resource utilization efficiency, increase a job throughput, and reduce service resource costs.

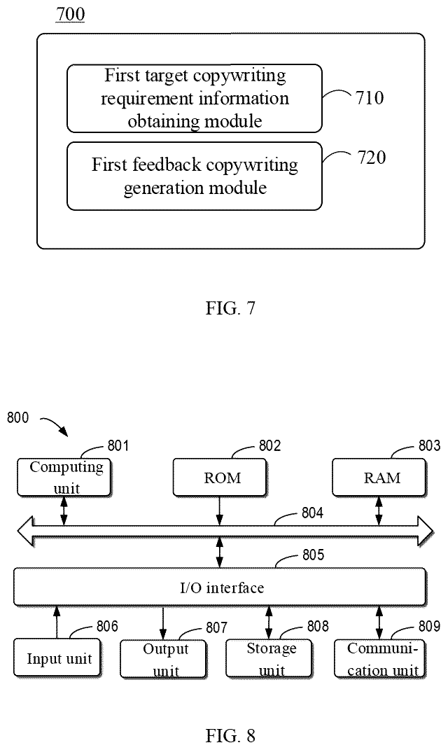

FIG. 7 schematically shows a block diagram of an copywriting generation apparatus according to embodiments of the present disclosure.

As shown in FIG. 7, a copywriting generation apparatus 700 may include a first target copywriting requirement information obtaining module 710 and a first feedback copywriting generation module 720.

The first target copywriting requirement information obtaining module 710 is used to update, in response to an input copywriting requirement information being received, a copywriting prompt information in the copywriting requirement information according to a copywriting generation operation related to the copywriting requirement information, so as to obtain a first target copywriting requirement information. The first target copywriting requirement information includes a target copywriting prompt information related to a semantic attribute of the copywriting requirement information.

The first feedback copywriting generation module 720 is used to process the first target copywriting requirement information based on a pre-trained deep learning model, so as to generate a first feedback copywriting corresponding to the copywriting requirement information.

According to embodiments of the present disclosure, the copywriting requirement information is associated with an association requirement information, and an association prompt information corresponding to the association requirement information is matched with the copywriting prompt information.

According to embodiments of the present disclosure, the first target copywriting requirement information obtaining module includes a copywriting prompt information update sub-module.

The copywriting prompt information update sub-module is used to update the copywriting prompt information according to the association requirement information and the copywriting requirement information to obtain the first target copywriting requirement information, in response to a operation type of the copywriting generation operation being a first operation type.

According to embodiments of the present disclosure, the copywriting prompt information update sub-module includes a feature extraction unit, a fusion requirement feature obtaining unit, and a copywriting prompt information update unit.

The feature extraction unit is used to perform a feature extraction on the association requirement information and the copywriting requirement information to obtain an association requirement feature and a copywriting requirement feature, respectively.

The fusion requirement feature obtaining unit is used to fuse the association requirement feature and the copywriting requirement feature based on an attention mechanism to obtain a fusion requirement feature.

The copywriting prompt information update unit is used to update the copywriting prompt information according to the fusion requirement feature.

According to embodiments of the present disclosure, the association requirement information includes a historical requirement information associated with a target object, and the copywriting requirement information is generated based on a requirement information input operation corresponding to the target object.

According to embodiments of the present disclosure, the copywriting generation apparatus may further include a recommended copywriting prompt template determination module.

The recommended copywriting prompt template determination module is used to determine, from a predetermined copywriting prompt template library, a recommended copywriting prompt template matched with the semantic attribute of the copywriting requirement information according to the copywriting requirement information.

According to embodiments of the present disclosure, the recommended copywriting prompt template determination module includes a copywriting requirement feature obtaining sub-module, a feature matching result obtaining sub-module.

The copywriting requirement feature obtaining sub-module is used to perform a semantic feature extraction on the copywriting requirement information to obtain a copywriting requirement feature.

The feature matching result obtaining sub-module is used to match a copywriting prompt template feature associated with a copywriting prompt template with the copywriting requirement feature to obtain a feature matching result, where the copywriting prompt template is contained in the predetermined copywriting prompt template library.

The recommended copywriting prompt template determination sub-module is used to determine, from the predetermined copywriting prompt template library, the recommended copywriting prompt template matched with the semantic attribute of the copywriting requirement information according to the feature matching result.

According to embodiments of the present disclosure, the copywriting generation apparatus may further include a second target copywriting requirement information generation module and a second feedback copywriting generation module.

The second target copywriting requirement information generation module is used to generate a second target copywriting requirement information in response to an editing operation on the recommended copywriting prompt template.

The second feedback copywriting generation module is used to process the second target copywriting requirement information according to the deep learning model to generate a second feedback copywriting.

According to embodiments of the present disclosure, the copywriting generation apparatus may further include a requirement keyword obtaining module.

The requirement keyword obtaining module is used to extract a requirement keyword related to a requirement attribute from the copywriting requirement information.

According to embodiments of the present disclosure, the first target copywriting requirement information obtaining module includes an embedding position determination sub-module and a requirement keyword embedding sub-module.

The embedding position determination sub-module is used to determine an embedding position corresponding to the requirement keyword from the recommended copywriting prompt template, in response to a operation type of the copywriting generation operation being a second operation type.

The requirement keyword embedding sub-module is used to embed the requirement keyword into the recommended copywriting prompt template based on the embedding position to obtain the first target copywriting requirement information.

According to embodiments of the present disclosure, the copywriting generation apparatus may further include a first custom template library update module.

The first custom template library update module is used to update a custom template library corresponding to a target object according to the recommended copywriting prompt template to obtain an updated custom template library, where a custom copywriting prompt template in the custom template library is presented to the target object in response to an operation authority of the target object being verified successfully.

According to embodiments of the present disclosure, the copywriting generation apparatus may further include a custom copywriting prompt template optimization module and a second custom template library update module.

The custom copywriting prompt template optimization module is used to process, in response to a template optimization operation corresponding to a target object, a copywriting prompt template to be optimized corresponding to the template optimization operation according to an attention mechanism algorithm, so as to obtain an optimized custom copywriting prompt template.

The second custom template library update module is used to update a custom template library corresponding to the target object according to the optimized custom copywriting prompt template to obtain an updated custom template library.

According to embodiments of the present disclosure, the copywriting prompt template to be optimized is generated based on a prompt information editing operation corresponding to the target object.

According to embodiments of the present disclosure, the copywriting prompt template to be optimized is determined from the custom template library corresponding to the target object.

According to embodiments of the present disclosure, the copywriting generation apparatus may further include a training sample determination module and a training module.

The training sample determination module is used to determine a training sample according to the updated custom template library, in response to a model update request related to the target object.

The training module is used to train the deep learning model according to the training sample to obtain an updated target deep learning model.

According to embodiments of the present disclosure, the training module includes a training task execution sub-module, a candidate model parameter obtaining sub-module, a target model parameter determination sub-module, and a target deep learning model determination sub-module.

The training task execution sub-module is used to execute an i^{th} training task on an (i−1)^{th} candidate deep learning model according to the training sample to obtain an i^{th} candidate model parameter of an i^{th} candidate deep learning model.

The candidate model parameter obtaining sub-module is used to obtain respective candidate model parameters of I candidate deep learning models in a case of I=i, where I≥i>1, and a first candidate deep learning model is the deep learning model.

The target model parameter determination sub-module is used to determine a target model parameter from the I candidate model parameters according to a model selection operation related to the target object.

The target deep learning model determination sub-module is used to obtain an updated target deep learning model according to the target model parameter.

According to embodiments of the present disclosure, a speech copywriting type, an information collection type, a reply information type, a text rewriting type.

According to embodiments of the present disclosure, the present disclosure further provides an electronic device, a readable storage medium, and a computer program product.

According to embodiments of the present disclosure, an electronic device is provided, including: at least one processor; and a memory communicatively connected to the at least one processor. The memory stores instructions executable by the at least one processor, and the instructions, when executed by the at least one processor, are used to cause the at least one processor to implement the methods described above.

According to embodiments of the present disclosure, a non-transitory computer-readable storage medium having computer instructions therein is provided, and the computer instructions are used to cause a computer to implement the methods described above.

According to embodiments of the present disclosure, a computer program product containing a computer program is provided, and the computer program, when executed by a processor, is used to cause the processor to implement the method described above.

FIG. 8 shows a schematic block diagram of an example electronic device 800 for implementing embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 8, the electronic device 800 includes a computing unit 801 which may perform various appropriate actions and processes according to a computer program stored in a read only memory (ROM) 802 or a computer program loaded from a storage unit 808 into a random access memory (RAM) 803. In the RAM 803, various programs and data necessary for an operation of the electronic device 800 may also be stored. The computing unit 801, the ROM 802 and the RAM 803 are connected to each other through a bus 804. An input/output (I/O) interface 805 is also connected to the bus 804.

A plurality of components in the electronic device 800 are connected to the I/O interface 805, including: an input unit 806, such as a keyboard, or a mouse; an output unit 807, such as displays or speakers of various types; a storage unit 808, such as a disk, or an optical disc; and a communication unit 809, such as a network card, a modem, or a wireless communication transceiver. The communication unit 809 allows the electronic device 800 to exchange information/data with other devices through a computer network such as Internet and/or various telecommunication networks.

The computing unit 801 may be various general-purpose and/or dedicated processing assemblies having processing and computing capabilities. Some examples of the computing unit 801 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 801 executes various methods and processes described above, such as the copywriting generation method. For example, in some embodiments, the copywriting generation method may be implemented as a computer software program which is tangibly embodied in a machine-readable medium, such as the storage unit 808. In some embodiments, the computer program may be partially or entirely loaded and/or installed in the electronic device 800 via the ROM 802 and/or the communication unit 809. The computer program, when loaded in the RAM 803 and executed by the computing unit 801, may execute one or more steps in the copywriting generation method described above. Alternatively, in other embodiments, the computing unit 801 may be used to perform the copywriting generation method by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, speech input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. A relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A copywriting generation method, comprising:
updating, in response to an input copywriting requirement information being received, a copywriting prompt information in the copywriting requirement information according to a copywriting generation operation related to the copywriting requirement information, so as to obtain a first target copywriting requirement information, wherein the first target copywriting requirement information comprises a target copywriting prompt information related to a semantic attribute of the copywriting requirement information; and
processing the first target copywriting requirement information based on a pre-trained deep learning model, so as to generate a first feedback copywriting corresponding to the copywriting requirement information.

2. The method according to claim 1, wherein the copywriting requirement information is associated with an association requirement information, and an association prompt information corresponding to the association requirement information is matched with the copywriting prompt information; and
wherein updating the copywriting prompt information in the copywriting requirement information according to the copywriting generation operation related to the copywriting requirement information so as to obtain the first target copywriting requirement information comprises:
updating the copywriting prompt information according to the association requirement information and the copywriting requirement information to obtain the first target copywriting requirement information, in response to a operation type of the copywriting generation operation being a first operation type.

3. The method according to claim 2, wherein the updating the copywriting prompt information according to the association requirement information and the copywriting requirement information comprises:
performing a feature extraction on the association requirement information and the copywriting requirement information to obtain an association requirement feature and a copywriting requirement feature, respectively;
fusing the association requirement feature and the copywriting requirement feature based on an attention mechanism to obtain a fusion requirement feature; and
updating the copywriting prompt information according to the fusion requirement feature.

4. The method according to claim 2, wherein the association requirement information comprises a historical requirement information associated with a target object, and the copywriting requirement information is generated based on a requirement information input operation corresponding to the target object.

5. The method according to claim 1, further comprising:
determining, from a predetermined copywriting prompt template library, a recommended copywriting prompt template matched with the semantic attribute of the copywriting requirement information according to the copywriting requirement information.

6. The method according to claim 5, wherein the determining, from a predetermined copywriting prompt template library, a recommended copywriting prompt template matched with the semantic attribute of the copywriting requirement information according to the copywriting requirement information comprises:
performing a semantic feature extraction on the copywriting requirement information to obtain a copywriting requirement feature;
matching a copywriting prompt template feature associated with a copywriting prompt template with the copywriting requirement feature to obtain a feature matching result, wherein the copywriting prompt template is contained in the predetermined copywriting prompt template library; and
determining, from the predetermined copywriting prompt template library, the recommended copywriting prompt template matched with the semantic attribute of the copywriting requirement information according to the feature matching result.

7. The method according to claim 6, further comprising:
generating a second target copywriting requirement information in response to an editing operation on the recommended copywriting prompt template; and
processing the second target copywriting requirement information according to the deep learning model to generate a second feedback copywriting.

8. The method according to claim 6, further comprising:
extracting, from the copywriting requirement information, a requirement keyword related to a requirement attribute;
wherein updating the copywriting prompt information in the copywriting requirement information according to the copywriting generation operation related to the copywriting requirement information to obtain the first target copywriting requirement information comprises:
determining an embedding position corresponding to the requirement keyword from the recommended copywriting prompt template, in response to a operation type of the copywriting generation operation being a second operation type; and
embedding the requirement keyword into the recommended copywriting prompt template based on the embedding position to obtain the first target copywriting requirement information.

9. The method according to claim 6, further comprising:
updating a custom template library corresponding to a target object according to the recommended copywriting prompt template to obtain an updated custom template library, wherein in response to an operation authority of the target object being verified successfully, a custom copywriting prompt template in the custom template library is presented to the target object.

10. The method according to claim 1, further comprising:
processing, in response to a template optimization operation corresponding to a target object, a copywriting prompt template to be optimized corresponding to the template optimization operation according to an attention mechanism algorithm, so as to obtain an optimized custom copywriting prompt template; and
updating a custom template library corresponding to the target object according to the optimized custom copywriting prompt template to obtain an updated custom template library.

11. The method according to claim 10, wherein the copywriting prompt template to be optimized is generated based on a prompt information editing operation corresponding to the target object.

12. The method according to claim 9, wherein the copywriting prompt template to be optimized is determined from the custom template library corresponding to the target object.

13. The method according to claim 9, further comprising:
determining a training sample according to the updated custom template library, in response to a model update request related to the target object; and
training the deep learning model according to the training sample to obtain an updated target deep learning model.

14. The method according to claim 13, wherein the training the deep learning model according to the training sample to obtain an updated target deep learning model comprises:
executing an i^{th} training task on an (i−1)^{th} candidate deep learning model according to the training sample to obtain an i^{th} candidate model parameter of an i^{th} candidate deep learning model;
obtaining respective candidate model parameters of I candidate deep learning models in a case of I=i, wherein I≥i>1, and a first candidate deep learning model is the deep learning model;
determining a target model parameter from the I candidate model parameters according to a model selection operation related to the target object; and
obtaining the updated target deep learning model according to the target model parameter.

15. The method according to claim 1, wherein a copywriting type of the first feedback copywriting is a speech copywriting type, an information collection type, a reply information type, or a text rewriting type; or a copywriting type of the first feedback copywriting is a combination of two or more of a speech copywriting type, an information collection type, a reply information type, and a text rewriting type.

16. An electronic device, comprising:
at least one processor; and
a memory communicatively connected to the at least one processor, wherein the memory stores instructions executable by the at least one processor, and the instructions, when executed by the at least one processor, are configured to cause the at least one processor to at least:
update, in response to an input copywriting requirement information being received, a copywriting prompt information in the copywriting requirement information according to a copywriting generation operation related to the copywriting requirement information, so as to obtain a first target copywriting requirement information, wherein the first target copywriting requirement information comprises a target copywriting prompt information related to a semantic attribute of the copywriting requirement information; and
process the first target copywriting requirement information based on a pre-trained deep learning model, so as to generate a first feedback copywriting corresponding to the copywriting requirement information.

17. The electronic device according to claim 16, wherein the copywriting requirement information is associated with an association requirement information, and an association prompt information corresponding to the association requirement information is matched with the copywriting prompt information; and
wherein the instructions are further configured to cause the at least one processor to at least:
update the copywriting prompt information according to the association requirement information and the copywriting requirement information to obtain the first target copywriting requirement information, in response to a operation type of the copywriting generation operation being a first operation type.

18. The electronic device according to claim 17, wherein the instructions are further configured to cause the at least one processor to at least:
perform a feature extraction on the association requirement information and the copywriting requirement information to obtain an association requirement feature and a copywriting requirement feature, respectively;
fuse the association requirement feature and the copywriting requirement feature based on an attention mechanism to obtain a fusion requirement feature; and
update the copywriting prompt information according to the fusion requirement feature.

19. The electronic device according to claim 17, wherein the association requirement information comprises a historical requirement information associated with a target object, and the copywriting requirement information is generated based on a requirement information input operation corresponding to the target object.

20. A non-transitory computer-readable storage medium having computer instructions therein, wherein the computer instructions are configured to cause a computer to at least:
update, in response to an input copywriting requirement information being received, a copywriting prompt information in the copywriting requirement information according to a copywriting generation operation related to the copywriting requirement information, so as to obtain a first target copywriting requirement information, wherein the first target copywriting requirement information comprises a target copywriting prompt information related to a semantic attribute of the copywriting requirement information; and
process the first target copywriting requirement information based on a pre-trained deep learning model, so as to generate a first feedback copywriting corresponding to the copywriting requirement information.
